(19) United States
(12) Patent Application Publication
(10) Pub. No.: US 2007/0187900 A1
(43) Pub. Date: Aug. 16, 2007

(54) Non-metallic brush seals

(75) Inventor: Amitava Datta, East Greenwich, RI (US)

Correspondence Address: BOWDITCH & DEWEY, LLP, 311 MAIN STREET, P.O. BOX 15156, WORCESTER, MA, 01615-0156, US

(73) Assignee: Advanced Components & Materials, Inc., East Greenwich, RI (US)

(21) Appl. No.: 11/121,872

(22) Filed: May 4, 2005

Related U.S. Application Data
(60) Provisional application No. 60/567,905, filed on May 4, 2004.

(51) Int. Cl. F16J 15/44

(52) U.S. Cl. 277/355

(57) ABSTRACT

A non-metallic brush seal for use in high temperature applications includes a plurality of bristles fabricated from polymeric or ceramic materials that are twisted together along the length of the bristles.

### CROSS REFERENCES TO RELATED APPLICATIONS

The present application claims the benefit of U.S. Provisional Application No. 60/567,905, filed May 4, 2004. The entire contents of the above application is incorporated herein by reference in entirety.

### TECHNICAL FIELD

This invention relates generally to non-metallic brush seals for sealing a gap between a high pressure and a low pressure area and, more particularly, to a brush seal made from braided ceramic or polymeric bristles.

### BACKGROUND

The use of brush seals for sealing gaps, such as those found in gas turbine engines, is known in the art. For example, in gas turbine engines brush seals are often utilized to minimize leakage of fluids at circumferential gaps, such as between a machine housing and a rotor, around a rotary shaft of the engine, and between two spaces having different fluid pressure within the engine. The fluid pressure within the system, which may be either liquid or gas, is greater than the discharge pressure (the pressure outside the area of the engine housing, toward which the fluid will tend to leak), thus creating a pressure differential in the system. As used herein, the system pressure side of the brush seal is referred to as the high pressure side, while the discharge pressure side of the brush seal is referred to as the low pressure side.

Conventional brush seals include a bristle pack which is traditionally flexible and includes a plurality of bristles for sealing the gap, the bristles having a free end for contacting one component, such as the rotor. Circular brush seals have been utilized in gas turbine engine applications to minimize leakage and increase engine fuel efficiency. Conventional brush seals are made from metallic fibers, which are typically cobalt or nickel-base high temperature superalloy wire products suitable for elevated temperature operation. Because brush seals are contacting seals where bristle tips establish sealing contacts against the rotor surface, their applications are generally limited to surface speeds of less than about 1200 ft/sec and temperatures below about 1500° F. and usually below about 1200-1300° F. At extremely high surface speeds and temperatures, metallic brush seals have been found to suffer from excessive wear resulting from bristle tip melting. There are many areas in existing gas turbine engines, such as balance piston and other secondary flow areas near the gas path where surface speed and temperature conditions are typically beyond the capabilities of conventional metallic brush seals. As such, these locations are generally sealed by large-gap labyrinth seals which have been found to have high levels of leakage during use as compared to contacting seals such as carbon seals and metallic brush seals. Rotating intershaft seals, for both co-rotating and counter-rotating shafts, for example in advanced military aircraft engines, are also generally labyrinth type seals.

Metallic brush seals are also traditionally not used for sealing buffer air near the bearing cavity. Buffer air is used to seal the bearing lubricant by pressurizing the buffer air higher than that of bearing lubricating oil pressure. Metallic brush seals are not used because of metallic debris could reach the interface between the bearing elements (balls, pins . . . ) and races causing bearing and rotor damage and possibly failure. Again, current seals used at these locations are generally high-leakage labyrinth seals. Higher leakage for bearing oil seals is not desirable because of contamination of downstream components and cabin air that can be introduced through the leak path. Appropriate carbon seals have not yet been developed for such applications because of their fragile characteristics and low damage tolerance.

Large diameter main shaft bearing oil seals for large aircraft engines or land based turbo machinery are also typically labyrinth seals with large clearances that lead to oil contamination. In these applications large diameter carbon seals are expensive and metallic brush seals are not suitable.

Although there have been developments in creating non-metallic brush seals, the use of polymeric or ceramic material to replace the metallic bristles has met with many design challenges due, in part, to the difficulty in handling and fabricating brush seals from such material. Typically ceramic or polymeric fibers are very thin, averaging in the range of about 2-3 μ m in diameter. Fibers that are this thin have not traditionally been considered suitable for fabricating bristle strips. For example, the flexibility of the fibers can make it difficult to machine the inner diameter (ID) of the brush seal to the required tolerances.

Therefore, there exists a need for a contacting seal that minimizes leakage as compared to traditional labyrinth type seals and which can operate under higher temperatures and/or higher speeds than existing metallic brush seals and which can be readily fabricated.

### SUMMARY

In accordance with the present invention, there is provided a contacting brush seal including a plurality of bristles fabricated from non-metallic materials, the bristles being twisted or braided together substantially along their length (L). The bristles may be particularly made from ceramic or polymeric materials, and in one embodiment are more particularly fabricated from NOMEX®, a synthetic aromatic polyamide polymer, manufactured by DuPont for high temperature applications. The brush seals disclosed herein have melting points much higher than those of nickel and cobalt base superalloys and, therefore, should prevent the bristle tips from melting under most conditions. In addition, brush seals made from softer high strength polymeric fibers with moderate (about 500-700° F.) temperature capability, may also be used for high performance bearings such as counter-rotating bearing cavities of advanced gas turbine engines.

### BRIEF DESCRIPTION OF THE DRAWINGS

It should be understood that the drawings are provided for the purpose of illustration only and are not intended to define the limits of the invention. The present invention is not limited to the precise arrangements and instrumentalities shown in the drawings, and the drawings are not necessarily to scale, emphasis instead being placed upon illustrating the principles disclosed herein, wherein:

FIG. 1 is a perspective view of a mechanically captured prior art brush seal;

FIG. 2 is schematic illustration of a polymeric brush seal design including a flexible front and back plate;

FIG. 3 is a schematic illustration of the flexible front and back plates of FIG. 2 including radial slots; and

FIG. 4 is a photograph of twisted NOMEX® brand fibers for the brush seal of FIGS. 1 and 2.

### DETAILED DESCRIPTION OF THE PREFERRED EMBODIMENT

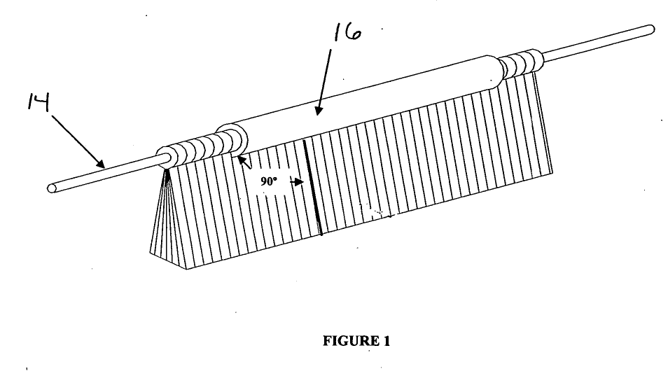

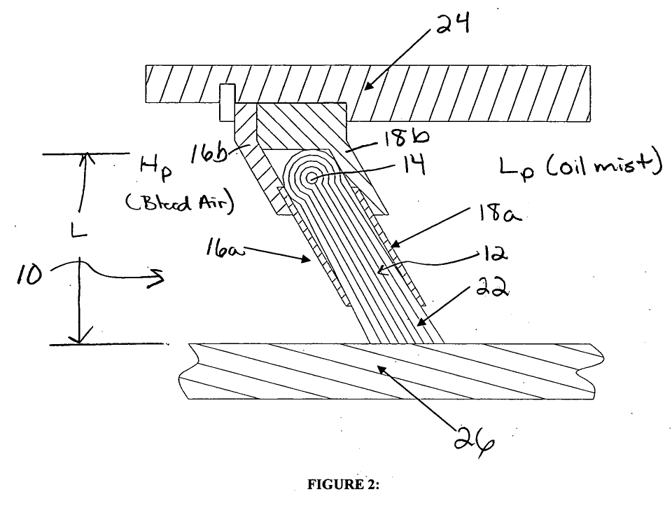

Referring initially to FIG. 2, there is illustrated a non-metallic brush seal 10 including a plurality of ceramic or polymeric bristles 12 supported around a rod or core 14. Because ceramic or polymeric bristles cannot be welded like metallic bristles 13 to fabricate brush seals, the ceramic or polymeric bristles are mechanically captured and secured. The bristles may be folded or wound about the core as shown schematically in FIG. 2. In the present embodiment, a clamping channel 16, such as the conventional channel shown in FIG. 1, or U-ring, may be utilized to further secure the bristles to the core wire 14 by crimping the channel over the wound bristles. For added security, the bristles may be glued or cemented to the rod in the mechanically captured condition, as desired.

These ceramic or polymeric bristles 12 are preferably twisted or braided into thicker diameter filaments about 0.02″-0.05″ in diameters. Brush seals can be fabricated from these braided filaments as described below. Ceramic bristles may be made from suitable high temperature ceramic filaments, including, but not limited to: Aluminum Oxide/Silicon Oxide/Boron Oxide or Nextel™ fiber; Silicon carbide fiber; other ceramic fibers generally made for ceramic/metal or ceramic/ceramic composites. Polymeric bristles may be made from suitable high temperature ceramic materials, including, but not limited to: KEVLAR® brand filaments for extremely high strength; and NOMEX® filaments for high strength and moderate temperature (˜300° C.) applications. Both KEVLAR® and NOMEX®D are synthetic aromatic polyamide polymer manufactured by DuPont. Other suitable polymeric materials may be utilized for the twisted or braided filaments for brush seals, as would be known to those of skill in the art.

In the present embodiment, NOMEX®, has been selected for brush seal fabrication because the NOMEX® fibers are generally made into strong fabrics for applications where thermal and flame resistant properties are essential. NOMEX® is the high temperature version of KEVLAR® which is as strong as or stronger than high strength steel. Other general properties of NOMEX®& include: 1.) usable in wide range of temperatures from −196° C. to over 300° C.; 2.) broad compatibility with industrially used oils, resins, adhesives and refrigerants; 3.) chemical resistance to acids, alkalis and solvents; 4.) non-toxic; 5.) self-extinguishing; 6.) does not support combustion; and 7.) does not drip or melt when heated or burned.

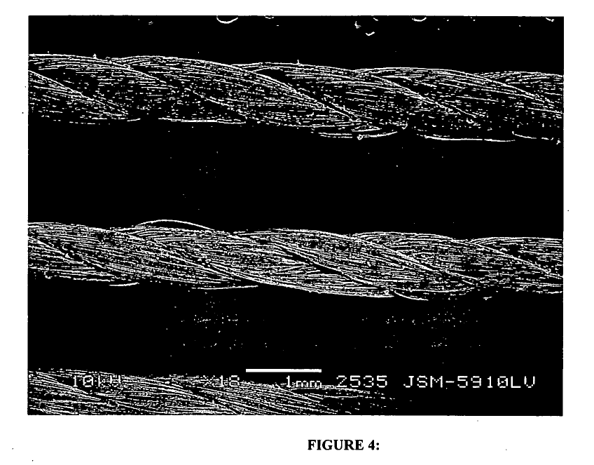

NOMEX® fibers are very thin, in the range of about 25μ m to .001″ in diameter, and have a low modulus of elasticity. In the present embodiment, the fibers are twisted as shown in FIG. 4 to fabricate the brush strips. The twisted NOMEX® fibers are much thicker than the individual fibers, the twisted fibers having a thickness in the range of about 900μ m to .036″ in diameter and they are rigid enough to make brush strips using the conventional automatic brush strip manufacturing process. This helps to reduce the fabrication cost of NOMEX® brush strips which will be formed or rolled into brush seal inserts as explained below.

Current automated mechanically captured brush strip manufacturing process is suitable for producing brush strips where bristle are inclined at about 90° to the strip axis and normal to the rotor surface as shown in FIG. 1. Typically, for metallic brush seals bristles are inclined at about 0° to 45° to the strip length in the direction of rotation to provide flexibility and aid in bristle bending during rotor excursion. When bristles are normal to the strip length or rotor surface, they tend to buckle rather than bend, thereby increasing the mechanical contact pressure (P_{mc}) at bristle tips. Increased P_{mc} accelerates bristle wear and shortens the seal life.

In the present embodiment, in order to facilitate bending of polymeric fibers during rotor excursions, the fiber strip is inclined axially in the direction of the fluid flow, i.e., toward the low pressure (L_{P}) side. To provide some rigidity, the flexible fiber pack 12 is held in an axially inclined position between a pair of thinner front 16a and back 18a plates which are attached to more rigid front 16b and back 18b plates as shown in FIG. 2.

The thinner and more flexible front and back plates, located near the ID of the brush seal, protect the filaments from damage during installation, aid in holding the fiber pack together, and minimize its flaring. The flexible plates help to control axial and radial displacements by supporting the fiber pack against pressure and centrifugal forces. The front plate may be fabricated from thin metallic strip which is supposed to contact the bristle pack when the system builds up pressure. Thus, the front plate acts as a flow deflector minimizing bristle blow-down on the rotating surface causing excessive bristle wear. The flexible back plate may also be made from a metallic sheet stock. However, its thickness may be greater than the front plate thickness. The thicker back plate is designed to support the bristle pack under pressure. Both the flexible front and back plates may be held in position by a brush seal housing having a rigid front and back plate as shown in FIG. 2.

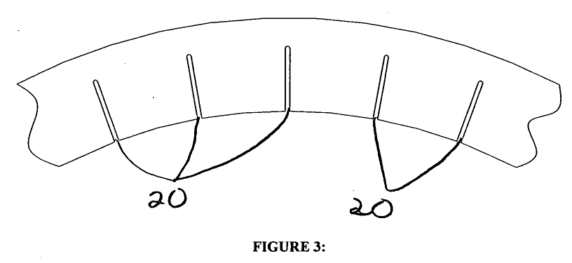

The flexible front and back plates may also be divided into segments by radial slots 20 as shown in FIG. 3, thereby allowing segments to bend. By optimizing the design of the radial segments of the flexible front and back plates, the displacement of the polymeric fiber pack caused by differential pressure and centrifugal forces at various operating conditions can be controlled. For example, the fiber pack is allowed to bend axially as the differential pressure and centrifugal force increase with the rotor speed. By controlling axial bending of the fiber pack, the radial clearance between the seal ID and rotor OD or its interference can be maintained relatively constant throughout the engine operating cycle.

The flexible plates may preferably extend a predetermined length of the bristles so as to expose only the bristle tip area 22, and protect the softer polymeric fibers from being damaged during installation and mishandling. The polymeric brush seal may be attached to the stator housing or to a rotating shaft 24 at a first end for an intershaft seal configuration and contact rotor 26 at a second end. For a rotating seal, the stresses in the polymeric fibers resulting from the centrifugal force are minimized as the fiber pack is supported by flexible metallic back plate segments. The metallic segments are designed to withstand the maximum bending stress due to centrifugal force. By securing the twisted fiber strips between axially inclined coned front and back plates in the direction of the fluid flow, the plates including a rigid annular section at the OD and flexible section at the ID, fiber pack displacement is controlled and stresses in the fiber pack are minimized.

An order of magnitude value of the maximum bending stress induced in a rotating flexible metallic segment is estimated in the following example. The following example is provided for purposes of illustration only and is not intended to limit the scope of the present invention.

Assuming that the flexible back plate is made from age hardened Inco 718 (density=0.295 lbm/(in)³ and Y.S=130,000 psi); the size of each finger segment:

width=1.0″, length=0.25″ and thickness=0.05″,
mass of each finger=1.0×0.25×0.05×0.295 lbm=0.0037 lbm.
and at the center of mass of each finger,

surface speed=500 ft/sec

radius=0.5 ft;
centrifugal force (F_{cf}) acting radially outward on each finger is given by:

$$\frac{( 0.0037 ) \times ( 500 )}{.5} lbf or {F}_{cf} = 1850 lbf .$$

If the cant angle of fingers w.r.t a vertical plane=10°, the bending force (Fₙ) acting normally through the center of mass of each finger
Fₙ=F_{cf} Sin 10°=1850×0.174=322 lbs
[Note: The F_{cf} will vary along the length of the finger and it needs to be integrated for a more accurate estimate]

Therefore, the maximum bending stress (σₘₐₓ) generated at the surface of each finger

$${σ}_{max} = \frac{3 \cdot {F}_{n} \cdot L}{w \cdot {t}^{2}}$$

where,
Fₙ=normal force acting through the center of mass=322 lbf
L=length of finger=0.25″
w=width of fingers=1″
t=thickness of finger=0.05″

$${σ}_{max} = \frac{3 x 322 x .25}{1 \times {( .05 )}^{2}} = 96 \text{,} 000 psi$$

This is well below the Y.S of Inco 718. The rest of the rigid structure of the rotating seal can easily be optimized to maintain stresses below the yield stress. For design optimization, detailed Finite Element Analysis (FEA) of the entire structure may be performed.

It will be appreciated that the braided ceramic or polymeric brush seals disclosed herein can operate effectively at relatively high temperatures (above about 1500° F.) and at high surface speeds (exceeding about 1000 ft/sec) while being capable of being manufactured using standard automatic and low-cost brush strip manufacturing process. Controlled bending of the flexible plate and fiber pack also aid in controlling seal radial clearance or interference throughout the operating cycle.

It will be understood that various modifications may be made to the embodiments disclosed herein. For example, although the fibers are illustrated as twisted, the term “twisted” as used herein is intended to include braided configurations, or any configuration where the fibers intentionally overlap or are wound about at least a portion of the length of the fibers. Likewise, non-metallic materials other than those described herein may be utilized for the twisted fibers. Therefore, the above description should not be construed as limiting, but merely as exemplifications of preferred embodiments. Those skilled in the art will envision other modifications within the scope, spirit and intent of the invention.

What is claimed:

1. A non metallic brush seal comprising:
a plurality of non-metallic bristles having a length, the bristles being twisted together substantially about their length such that the bristles overlap each other;
a support member constructed and arranged to support the bristles in the twisted configuration;
wherein the plurality of non-metallic bristles forms a fiber pack, and
wherein the support member comprises a metallic front plate and a metallic back plate which are constructed and arranged to elastically return the fiber pack from a displaced position to an original position in a spring back manner following displacement of the fiber pack.

2. (canceled)

3. The brush seal of claim 1, wherein the metallic front plate defines a set of slots extending from an inner diameter side toward an outer diameter side of the metallic front plate to divide the metallic front plate into multiple flexible front plate segments; and
wherein the metallic back plate defines a set of slots extending from an inner diameter side toward an outer diameter side of the metallic back plate to divide the metallic back plate into multiple flexible back plate segments.

4. The brush seal of claim 1, wherein each of the metallic front plate and the metallic back plate includes (i) a thicker outer diameter portion constructed and arranged to support the fiber pack against pressure in an operating environment, and (ii) a thinner inner diameter portion constructed and arranged constantly apply a holding force on the fiber pack to maintain contact between the fiber pack and an external object of the operating environment during operation.

5. The brush seal of claim 1, wherein the plurality of non-metallic bristles includes multiple braids, each braid including a first fiber and a second fiber which are wound together to form that braid.

6. The brush seal of claim 5, wherein the first fiber and the second fiber of each braid includes a ceramic bristle.

7. The brush seal of claim 5, wherein the first fiber and the second fiber of each braid includes a polymeric bristle.

8. The brush seal of claim 5, wherein the first fiber and the second fiber of each braid is formed of Aluminum Oxide, Silicon Oxide and Boron Oxide.

9. The brush seal of claim 5, wherein the first fiber and the second fiber of each braid has an individual fiber diameter; and
wherein a circular cross-section of each braid has a braid diameter which is thicker than the individual fiber diameter.

10. The brush seal of claim 5, wherein the multiple braids form a fiber strip; and
wherein the support member is constructed and arranged to mount to a base and to orient the fiber strip in an axially inclined position relative to the base.

11. The brush seal of claim 10, wherein the support member is constructed and arranged to position the fiber strip to extend toward a high pressure side when orienting the fiber strip in the axially inclined position relative to the base.

12. A non-metallic brush seal system, comprising:
a housing;
a rotatable shaft, the housing and the rotatable shaft defining a space; and
a non-metallic brush seal disposed between the housing and the rotatable shaft to divide the pathway into a higher pressure side and a lower pressure side, the non-metallic brush seal including (i) multiple non-metallic braids, each non-metallic braid including a first non-metallic fiber and a second non-metallic fiber which are wound together to form that braid, and (ii) a support member constructed and arranged to support the first non-metallic fiber and the second non-metallic fiber of each non-metallic braid in a twisted configuration,
wherein the non-metallic braids form a fiber pack, and
wherein the support member includes a metallic front plate and a metallic back plate which are constructed and arranged to elastically return the fiber pack from a displaced position to an original position in a spring back manner following displacement of the fiber pack.

13. (canceled)

14. The non-metallic brush seal system of claim 12, wherein the metallic front plate defines a set of slots extending from an inner diameter side toward an outer diameter side of the metallic front plate to divide the metallic front plate into multiple flexible front plate segments; and
wherein the metallic back plate defines a set of slots extending from an inner diameter side toward an outer diameter side of the metallic back plate to divide the metallic back plate into multiple flexible back plate segments.

15. The non-metallic brush seal system of claim 14, wherein the set of slots defined by each plate makes an inner diameter edge of that plate discontinuous to facilitate bending and tracking of the rotatable shaft during a radial excursion of the rotatable shaft relative to the housing.

16. The non-metallic brush seal system of claim 12, wherein each of the metallic front plate and the metallic back plate includes (i) a thicker outer diameter portion constructed and arranged to support the fiber pack against pressure in the space, and (ii) a thinner inner diameter portion constructed and arranged constantly apply a holding force on the fiber pack to maintain contact between the fiber pack and the rotatable shaft.

17. The non-metallic brush seal system of claim 12, wherein the first fiber and the second fiber of each braid includes a ceramic bristle.

18. The non-metallic brush seal system of claim 12, wherein the first fiber and the second fiber of each braid includes a polymeric bristle.

19. The non-metallic brush seal system of claim 12, wherein the first fiber and the second fiber of each braid is formed of Aluminum Oxide, Silicon Oxide and Boron Oxide.

20. The non-metallic brush seal system of claim 12, wherein the multiple braids of the non-metallic brush seal form a fiber strip; and
wherein the support member of the non-metallic brush seal is constructed and arranged to mount to the housing and to orient the fiber strip in an axially inclined position relative to an axis of rotation defined by the rotatable shaft.

21. The non-metallic brush seal system of claim 20, wherein the support member of the non-metallic brush seal is constructed and arranged to position the fiber strip to extend toward the high pressure side when orienting the fiber strip in the axially inclined position relative to the axis of rotation defined by the rotatable shaft.

22. A non-metallic brush seal to divide a pathway between a housing and a rotatable shaft into a higher pressure side and a lower pressure side, the non-metallic brush seal comprising:
multiple non-metallic braids, each non-metallic braid including a first non-metallic fiber and a second non-metallic fiber which are wound together to form that braid; and
a support member constructed and arranged to support the first non-metallic fiber and the second non-metallic fiber of each non-metallic braid in a twisted configuration while holding the non-metallic brush seal within the pathway between the housing and the rotatable shaft;
wherein the non-metallic braids form a fiber pack, and
wherein the support member includes a metallic front plate and a metallic back plate which are constructed and arranged to elastically return the fiber pack from a displaced position to an original position in a spring back manner following displacement of the fiber pack.
